(19) United States
(12) Patent Application Publication
(10) Pub. No.: US 2014/0152796 A1
(43) Pub. Date: Jun. 5, 2014

(54) AUTO FOCUS CONTROL APPARATUS, SEMICONDUCTOR INSPECTING APPARATUS AND MICROSCOPE

(71) Applicant: SAMSUNG ELECTRONICS CO., LTD., Suwon-si (KR)

(72) Inventors: Togashi Mitsuhiro, Yokohama-si (JP); Sekiya Harutaka, Yokohama-si (JP); Ueyama Shinji, Yokohama-si (JP)

(73) Assignee: SAMSUNG ELECTRONICS CO., LTD., Suwon-si (KR)

(21) Appl. No.: 14/086,341

(22) Filed: Nov. 21, 2013

(30) Foreign Application Priority Data
Nov. 21, 2012 (JP) 10-2012-255377

(51) Int. Cl. G02B 21/00; G02B 21/36; G03B 13/36

(52) U.S. Cl. CPC G02B 21/0016; G03B 13/36; G02B 21/361
USPC 348/79

(57) ABSTRACT

An auto focus control apparatus is provided to perform an auto focus adjustment using astigmatism without being affected by a pattern on a surface. A light receiving optical system includes an unpolarized beam splitter 420 separating a reflection light from an object into a first reflection light and a second reflection light, a first astigmatism producing means 430 arranged on an optical path of the first reflection light, a second astigmatism producing means 450 arranged on an optical path of the second reflection light, a first light detector 440 receiving a light passing through the first astigmatism producing means, and a second light detector 460 receiving a light passing through the second astigmatism producing means. The light source optical system 310 is arranged such that an image forming point of a focus error detecting light is defocused from an observation plane by a predetermined distance.

### PRIORITY STATEMENT

This application claims priority under 35 U.S.C. §119 to Japanese Patent Application No. 2012-255377, filed on Nov. 21, 2012 in the Japanese Intellectual Property Office, the contents of which are herein incorporated by reference in their entirety.

### BACKGROUND

1. Field

Example embodiments relate to an auto focus control apparatus, a semiconductor inspecting apparatus and a microscope. More particularly, example embodiments relate to an auto focus control apparatus and a semiconductor inspecting apparatus for inspecting a pattern on a surface of a semiconductor wafer.

2. Description of the Related Art

An apparatus for inspecting a semiconductor wafer is disclosed (for example, Patent document 1: Japanese Utility Model Registration No. 3003842). The apparatus for inspecting a semiconductor wafer, which picks up an image to inspect a surface of a semiconductor wafer, requires an auto focus adjustment.

Astigmatism is known for an auto focus control method (Paten document 2: Japanese Laid-open Publication No. S62-36502), and also, for example, is used to control a pick up for record and play-back of a magnetic disc or optical disc (Patent document 3: Japanese Laid-open Publication No. H9-17020).

As explained in the Patent document 3, since a pattern on the surface of the optical disc is regular, a rotational direction, a diffraction direction, an inclined angle and so on of a reflection beam are pre-set. Accordingly, when a cylindrical lens producing astigmatism is set to a predetermined direction, a precise auto focus control using astigmatism is possible without being affected by the pattern on the surface of the optical disc.

### CONVENTIONAL ART DOCUMENT

### Patent Document

Patent document 1: Japanese Utility Model Registration No. 3003842
Patent document 2: Japanese Laid-open Publication No. S62-36502
Patent document 3: Japanese Laid-open Publication No. H9-17020

### SUMMARY

However, an irregular pattern is formed on the surface of the semiconductor wafer, and disturbance or non-uniform light amount distribution occurs in a reflection light. Accordingly, an auto focus adjustment using astigmatism cannot be applied to the surface of the semiconductor wafer. Also, the auto focus adjustment using astigmatism cannot be applied to an object having an irregular pattern.

Example embodiments provide an auto focus control apparatus capable of performing an auto focus adjustment using astigmatism without being affected by a pattern on a surface.

According to example embodiments, an auto focus control apparatus for controlling a relative position of a surface of an object with respect to an observation plane in order to inspect the surface of the object using an observation optical system including an image sensor, includes

a light source optical system including a light source which emits a focus error detecting light;

a condenser lens condensing the focus error detecting light to an incident light to the surface of the object;

a light receiving optical system receiving a reflection light from the object through the condenser lens; and

a focus error signal generator generating a focus error signal using a receiving signal from the light receiving optical system,

wherein the light receiving optical system includes

an unpolarized beam splitter separating the reflection light from the object into a first reflection light and a second reflection light;

a first astigmatism producing means arranged on an optical path of the first reflection light;

a second astigmatism producing means arranged on an optical path of the second reflection light;

a first light detector receiving a light passing through the first astigmatism producing means; and

a second light detector receiving a light passing through the second astigmatism producing means,

wherein the focus error signal generator generates the focus error signal using the receiving signal from the first light detector and the second light detector,

wherein the light source optical system is arranged such that an image forming point of the focus error detecting light is defocused from the observation plane by a predetermined distance, and

wherein the light receiving optical system comprises an offset adjustment lens which adjusts such that the reflection light of the light defocused from the observation plane by the predetermined distance is focused on receiving surfaces of the first light detector and the second light detector.

### BRIEF DESCRIPTION OF THE DRAWINGS

Example embodiments will be more clearly understood from the following detailed description taken in conjunction with the accompanying drawings. FIGS. 1 to 13b represent non-limiting, example embodiments as described herein.

FIG. 1 is a view illustrating a semiconductor wafer inspecting apparatus in accordance with a first example embodiment.

FIG. 2 is a view illustrating a position relation between a beam spot and an observation region of an observation optical system.

FIG. 3 is a view illustrating an auto focus control system

FIG. 4 is a view illustrating a conventional general configuration for comparison.

FIG. 5 is a view illustrating an arrangement state of a condenser lens which is arranged to move closer an objective lens along a light axis.

FIG. 6 is a view illustrating a returning light from a surface of a semiconductor wafer.

FIGS. 7a to 7c are views illustrating a change of a light receiving image.

FIG. 8 is a view illustrating a focus error signal FE1 in case there is no light amount distribution.

FIGS. 9a to 9c are views illustrating a change of a light receiving image in case there is a light amount distribution.

FIG. 10 is a view illustrating an example of a focus error signal to be offset.

FIGS. 11a to 11c are views illustrating examples of light receiving images received in a second light detector.

FIG. 12 is a view illustrating the total focus error signal which an effect of the disturbance is removed from.

FIGS. 13a and 13b are views illustrating a modified example embodiment.

### DETAILED DESCRIPTION OF EXAMPLE EMBODIMENTS

Hereinafter, example embodiments will be explained in detail with reference to the accompanying drawings.

### First Example Embodiment

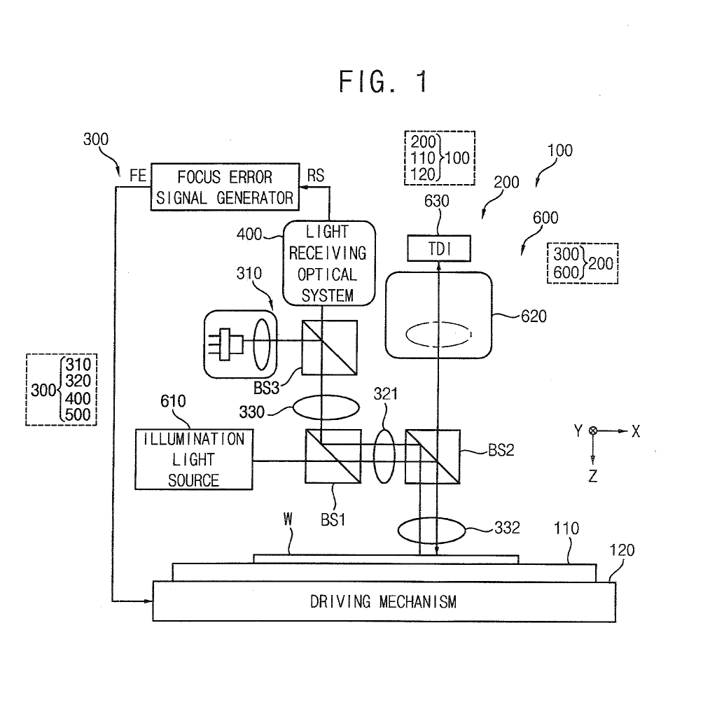

FIG. 1 represents a semiconductor wafer inspecting apparatus of a first example embodiment.

A semiconductor wafer inspecting apparatus 100 includes an optical unit 200, a stage 110 for supporting a semiconductor wafer W as an object to be inspected, and a driving mechanism 120 for moving the stage 110.

The optical unit 200 further includes an auto focus control system 300 and an observation optical system 600.

The auto focus control system 300 includes a light source optical system 310, an objective lens 322, a light receiving optical system 400, and a focus error signal generator 500.

The driving mechanism 120 moves the stage 110 such that the semiconductor wafer W moves relative to the optical unit 200. The driving mechanism 120 adjusts a position of the stage 110 so that the observation optical system 600 can observe a surface of the semiconductor wafer W. The driving mechanism 120 moves the stage 110 in X direction and Y direction to scan two-dimensionally across an observation area, and moves the stage 110 in Z direction to place the surface of the semiconductor wafer (W) in focus of the observation optical system 600.

In FIG. 1, the left and right direction on the paper is referred to as X direction, the vertical direction to the plane of the paper is referred to as Y direction, and the upper and lower direction on the paper is referred to as Z direction.

Additionally, in the specification, a plane including the focal point of the observation optical system 600 may be referred to as an observation plane.

Hereinafter, an optical path in the optical unit 200 will be explained briefly with reference to FIG. 1.

First, an optical path in the observation optical system 600 will be explained.

A light emitting from an illumination light source 610 is incident into the objective lens 322 through a first beam splitter BS1, a collimator lens 321 and a second beam splitter BS2 to illuminate the surface of the semiconductor wafer (W). A reflection light reflected from the semiconductor wafer (W) goes back to the objective lens 322 and the second beam splitter BS2 and further enter a two-dimensional image sensor 630 through an optical system 620. Image obtained by the image sensor 630 is used to inspect the surface of the semiconductor wafer (W).

Then, an optical path in the auto focus control system 300 will be explained.

A light (focus error detecting light) emitting from the light source optical system 310 is incident into the objective lens 322 through a third beam splitter BS3, a condenser lens 330, the first beam splitter BS1, the collimator lens 321 and the second beam splitter BS2 to form an image on the surface of the semiconductor wafer (W) (in here, the image is de-focused slightly with respect to the surface of the semiconductor wafer (W), which will be explained later). A reflection light reflected from the surface of the semiconductor wafer (W) goes back to the objective lens 322, the second beam splitter BS2, the collimator lens 321, the first beam splitter BS1, the condenser lens 330, and then, enters the light receiving optical system 400.

To further explain a signal path in relation thereto, a receiving signal GS from the light receiving optical system 400 is sent to the focus error signal generator 500, and a focus error signal FE from the focus error signal generator 500 is outputted to the driving mechanism 120. The driving mechanism 120 adjusts a position of the semiconductor wafer in the Z direction based on the focus error signal.

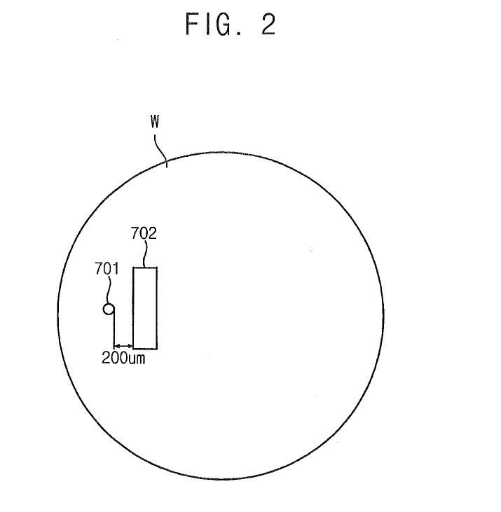

The first beam splitter BS1, the collimator lens 3221, the second beam splitter BS2 and the objective lens 322 are commonly used for both the observation optical system 600 and the auto focus control system 300. However, a position of a beam spot 701 used in the auto focus control system 300 does not coincide with a position of an observation region 702 of the observation optical system 600 (See FIG. 2).

FIG. 2 represents a position difference between a beam spot 701 of the auto focus control system 300 and an observation region 702 of the observation optical system 600. Because the beam spot 701 is spaced apart from the observation region 702, a disturbance such as a flare that occurs when a beam used in the auto focus control system 300 filters into the observation optical system 600 can be reduced or prevented.

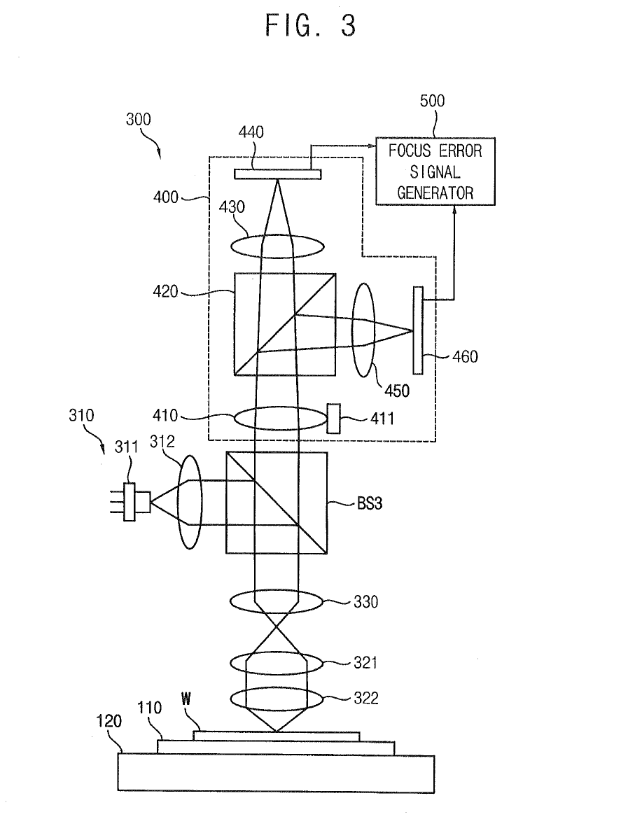

FIG. 3 represents the auto focus control system.

In FIG. 3, in order to explain easily the auto focus control system 300, the first beam splitter BS1 and the second beam splitter BS2 in FIG. 1 are omitted. Because the first beam splitter BS1 and the second beam splitter BS2 are used to connect the auto focus control system 300 and the observation optical system 600 to each other, it would be understood that the first beam splitter BS1 and the second beam splitter BS2 can not be considered as an optical component of the auto focus control system 300.

The auto focus control system 300 will be explained with reference to FIG. 3.

The light source optical system 310 includes a laser diode 311 as a light source, a collimator lens 312 collimating a light from the laser diode 311 into parallel light beams, and a condenser lens 330 condensing the parallel light beams from the collimator lens 312.

The light emitting from the laser diode 311 is a light within an ultraviolet region. For example, the light may be a laser beam having a wavelength of 405 nm. In order to control precisely a position, it may be preferable that the light has a relatively short wavelength.

The parallel light beams emitting from the light source optical system 310 are incident on the condenser lens 330 through the third beam splitter BS3 to be condensed.

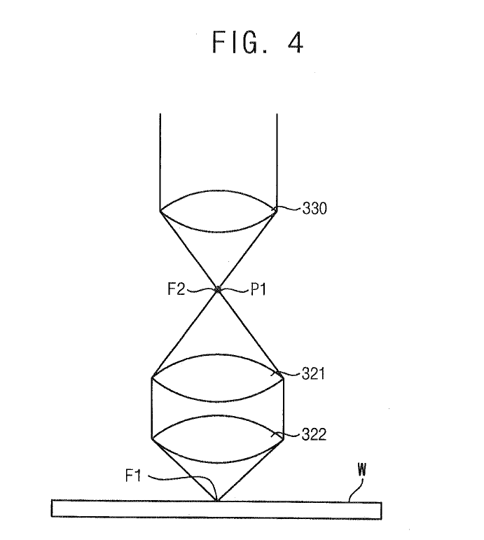

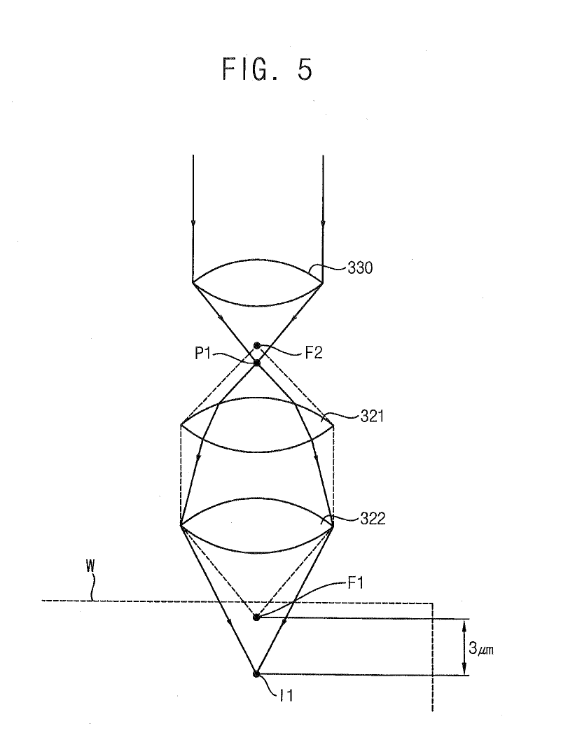

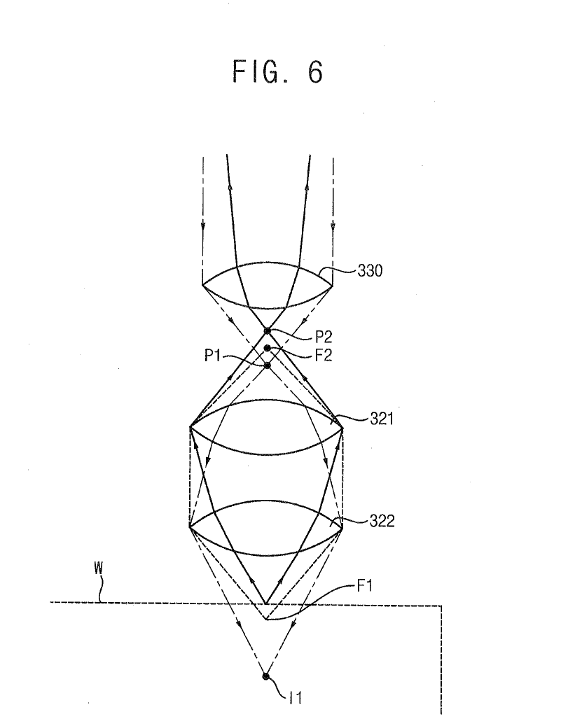

The condensing point is represented by P1 (for example, see FIG. 4. FIG. 5 and FIG. 6)

According to a conventional configuration, the condensing point P1 coincides with a focal point F2 of the collimator lens 321 (for your easy understanding, an infinite condenser lens is employed as the condenser lens. In case that a finite condenser lens is employed as the condenser lens, the configuration thereof is changed, however, the difference would be obvious to those skilled in the art.). FIG. 4 represents a conventional general configuration for comparison. In FIG. 4, the light condensed by the condenser lens 330 is converted into parallel light beams and further is condensed by the condenser lens 322. When a focus point F1 of the condenser lens 322 is placed on the surface of the semiconductor wafer (W), the light forms an image as a very minute spot on the surface of the semiconductor wafer (W) (the spot diameter is for example about 1 μm.). A light reflected by the surface of the semiconductor wafer (W) goes back to the condenser lens 322 and the collimator lens 312 to be condensed at the condensing point P1, and then, is converted into parallel light beams to enter the light receiving optical system 400.

In this embodiment, an arrangement relation between the condenser lens 330 and the collimator lens 321 is adjusted such that the condensing point P1 of the condenser lens 300 does not coincide with the focal point F2 of the collimator lens 321. FIG. 5 represents an arrangement relation where the condenser lens 330 is arranged to move closer to the collimator lens 321 in a light axis. Because the focal point P1 is spaced apart from the focal point F2 of the collimator lens 321, an image forming point I1 of the condenser lens 322 is away from the focal point F1 of the condenser lens 322.

FIG. 6 represents a light returning from the surface of the semiconductor wafer. In her, the image forming point I1 is away from the surface of the semiconductor wafer (W) (referred to as “defocused”). Thus, the reflection light reflected by the surface of the semiconductor wafer (W) goes back to the collimator lens 321 and then condensed at the point P2, which is away from the original condensing point P1. A light passing through the condenser lens 330 travels at an angle inclined with respect to a parallel direction.

As an amount of the defocus between the image forming point I1 and the surface of the semiconductor wafer (W) is determined, an angle deviation amount of the returning light is determined (in other words, when the angle deviation amount of the returning light is determined, the amount of the defocus between the image forming point I1 and the surface of the semiconductor wafer (W) is determined consequentially.).

In FIGS. 5 and 6, the sizes and relative sizes of the components are exaggerated for clarity. The spot size may be adjusted to have a desired diameter (for example, 10 μm). It may be preferable that the condensing point P1 is adjusted to be away from the focal point F2 of the condenser lens 322, and also, the surface of the semiconductor wafer (W) is spaced apart from the image forming point I1 by a predetermined distance. In here, the returning light passes through the condenser lens 330, and then, travels at a predetermined angle inclined with respect to a parallel direction to enter the light receiving optical system 400.

In order to dislocate the position of the condensing point P1 of the condenser lens 330, only a position of the condenser lens 330 may be displaced.

Alternatively, the laser diode 311 may be positioned to be in front of the focal point of the collimator lens 312 (the laser diode 311 may be moved or the collimator lens 312 may be moved.).

In this embodiment, the light source optical system 310 (the laser diode 311, the collimator lens 312 and the condenser lens 330) and the third beam splitter BS3 may be assembled into one unit. It may be preferable that the whole unit including the light source optical system 310 and the third beam splitter BS3 is moved.

In here, as mentioned above, the surface of the semiconductor wafer (W) is away (defocused) from the image forming point I1 by a predetermined distance.

The reason why the light is defocused from the surface of the semiconductor wafer (W) not focused, in this embodiment, will be explained.

In this embodiment, an objet to be inspected is a surface of a semiconductor wafer having a (irregular) pattern. Various patterns having the order of several micrometers may be formed on the surface of the semiconductor wafer. When a completely focused minimal spot beam is irradiated onto the semiconductor wafer (W), a reflection light therefrom may cause a serious effect on the pattern on the surface of the semiconductor wafer (W). For example, when the spot beam strikes an edge of the pattern, a reflection direction may be different from a direction to the condenser lens 322. Further, a reflection light amount may be changed according to a point where the spot beam strikes. In other words, even though the returning light is incident on a light receiving surface of the light receiving optical system 400, a light amount distribution in the far field may become drastically non-uniform, so that an auto focus control becomes impossible. For example, even though the focus is set, recognition becomes impossible.

In this embodiment, a light is not focused on the surface of the semiconductor wafer (W), but a light is defocused to increase a spot diameter. Thus, an effect on the pattern on the surface of the semiconductor wafer is reduced, an amount of the returning light is stabilized, and a control of a distance between the optical unit 200 and the surface of the semiconductor wafer (W) is stabilized.

Next, a configuration of the light receiving optical system 400 will be explained.

The light receiving optical system 400 includes an offset adjustment lens 410, an unpolarized beam splitter 420, a first cylindrical lens 430 as a first astigmatism producing means, a first light detector 440, a second cylindrical lens 450 as a second astigmatism producing means, and a second light detector 460.

The first light detector 440 and the second light detector 460 are quadrant detectors having four divided light receiving portions.

An optical path in the light receiving optical system 400 will be explained with respect to FIG. 3.

The returning light from the surface of the semiconductor wafer go back to the objective lens 322, the collimator lens 321 and the condenser lens 330, and then, enters the offset adjustment lens 410 through the third through the third beam splitter BS3. The light passing through the offset adjustment lens 410 is separated into two by the unpolarized beam splitter 420. One of the separated light beams is received in the first light detector 440 through the first cylindrical lens 430. Other separated light beam is received in the second light detector 460 through the second cylindrical lens 450.

Next, the offset adjustment lens 410 will be explained.

The offset adjustment lens 410 is arranged such that the light reflected from the semiconductor wafer (W) is focused on the receiving surfaces of the first light detector 440 and the second light detector 460.

As mentioned above, since a light is defocused on the surface of the semiconductor wafer (W), the reflection light passing through the condenser lens 330 travels at an angle inclined with respect to a parallel direction. In here, the offset adjustment lens 410 is arranged such that the incident light having a predetermined angle deviation is focused on the receiving surfaces of the first light detector 440 and the second light detector 460, to thereby detect whether or not the surface of the semiconductor wafer (W) is at a defocused position. In order to perform this offset adjustment, an actuator 411 is installed in the offset adjustment lens 410 to move the offset adjustment forward or backward along the light axis.

Double Astigmatism Method

Hereinafter, a double astigmatism method according to this embodiment will be explained.

Even though a simple astigmatism method is known well, the simple astigmatism method will be explained briefly for comparison.

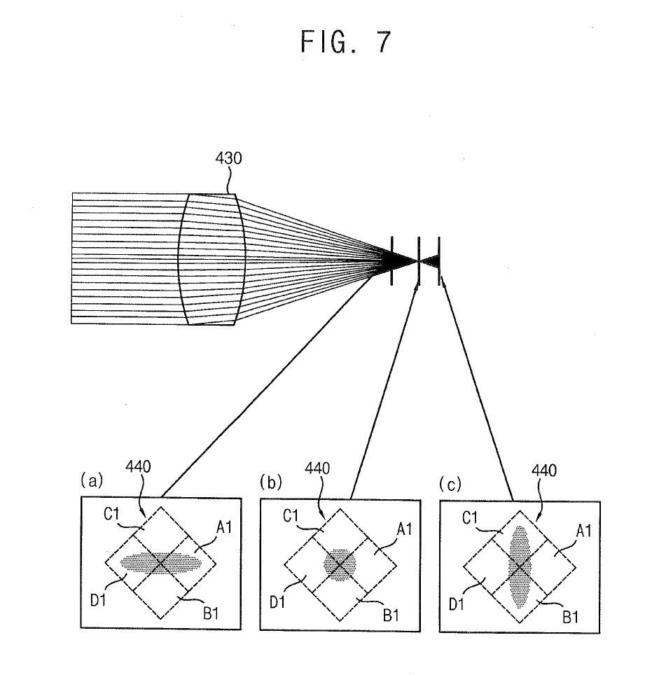

The astigmatism method is a method where a distortion of an image formed by an optical system with astigmatism is detected to measure a displacement in a light axis. For example, an image is changed according to a position of the light receiving surface of the first light detector 440 on which a light passing through the first cylindrical lens 430 is incident (FIG. 3), as illustrated in FIGS. 7a to 7c (a horizontally long elliptical shape (FIG. 7a), a circular shape (FIG. 7b), a vertically long elliptical shape (FIG. 7c)). The change is detected using the quadrant detector 440 to measure the displacement in the axial direction.

Four light receiving portions are represented in order by A to D, for example, a light receiving signal from a light receiving portion A is represented by ‘SA’ (when the light receiving portion is one of the light receiving portions of the first light detector 440, the light receiving portions are represented by A1 to D1, further, for example, the light receiving signal from the light receiving portion ‘A1’ is represented by ‘SA1’). The focus error signal is generated by the focus error signal generator 500. The focus error signal is defined in the following equation.

FE1=(SA1+SD1)−(SB1+SC1)

(that is, the sum in one diagonal direction minus the sum in other diagonal direction)

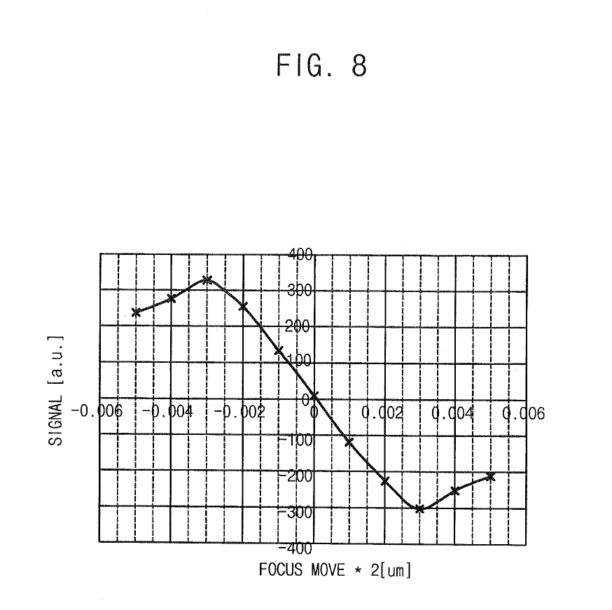

The focus error signal FE1 represents an ‘S’ shaped curve (see FIG. 8). When the detected FE1 is zero, the light receiving image is a circular shape. This means the light receiving surface of the first light detector 440 is in a focused state.

(Although it is illustrated for easy understanding in FIGS. 7a to 7c that the light receiving surface of the first light detector 440 moves, it would be understood that the semiconductor wafer (W) actually moves forward and backward along the light axis, and thus, the position of the image formed is displaced.)

If there is no light amount distribution of a reflection light from the surface of the semiconductor wafer (W), only one quadrant light receiving device 440 is used to perform the astigmatism method. However, because various patterns are formed on the surface of the semiconductor wafer (W), a non-uniform light amount distribution occurs due to diffraction or scattering.

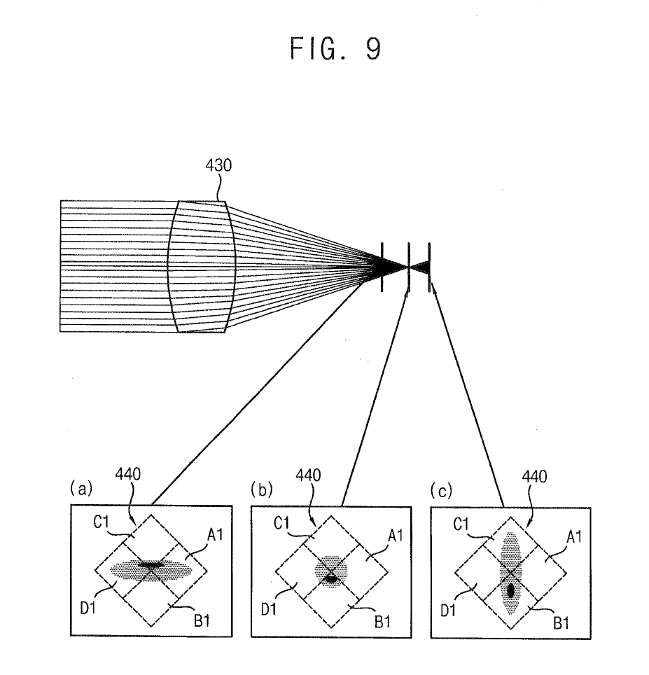

As an example of a non-uniform light amount distribution, in FIGS. 9a to 9c, a light receiving image in case the reflection light has an excluded portion (referred to as a defective portion) is illustrated. In here, the defective portion is detected in the light receiving portion B1 or the light receiving portion C1.

In case that there is the defective portion, the focus error signal FE1 is generated. Thus, the light amount portion (SB1+SC1) including the defective portion is decreased.

As illustrated in FIG. 9b, when the light receiving image is a circular shape, the focus error signal FE1 must be zero.

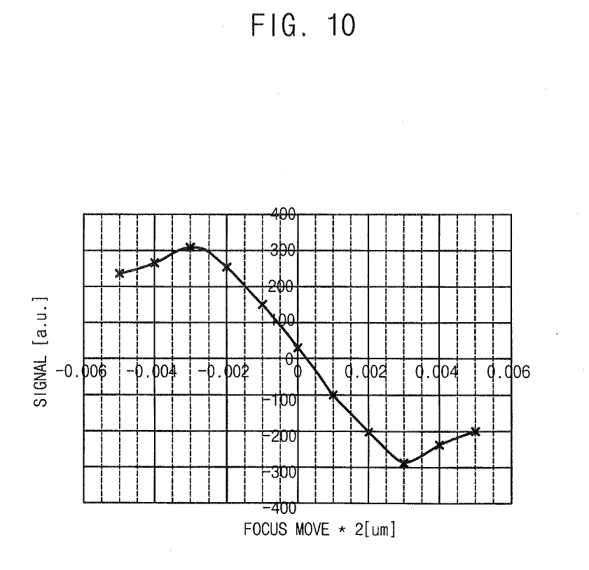

However, as illustrated in FIG. 10, because the ‘S’ shape curve is offset, the point where the focus error signal FE1 is zero moves to a point between FIG. 9b and FIG. 9c.

When a light strikes at difference places on the surface of the semiconductor wafer (W), the defective portion may occur or disappear, or increase or decrease. Accordingly, a distance adjustment between the optical unit 200 and the surface of the semiconductor wafer is unstable.

In this embodiment, the double astigmatism method is used to prevent the light amount distribution from causing an effect on the focus error signal.

That is, a light passing through the offset adjustment lens 410 is separated into two by the unpolarized beam splitter 420. One of the separated light beams is received in the first light detector 440 through the first cylindrical lens 430.

In this case, the light receiving image and the focus error signal FE1 is illustrated in FIGS. 9a to 9c and FIG. 10.

To take note of other separated light beam, the other separated light beam is a mirror image of the one separated light beam.

(because one is a light passing through the unpolarized beam splitter 420 and the other is a light reflected by the unpolarized beam splitter 420)

The other separated light beam is received in the second light detector 460 through the second cylindrical lens 450.

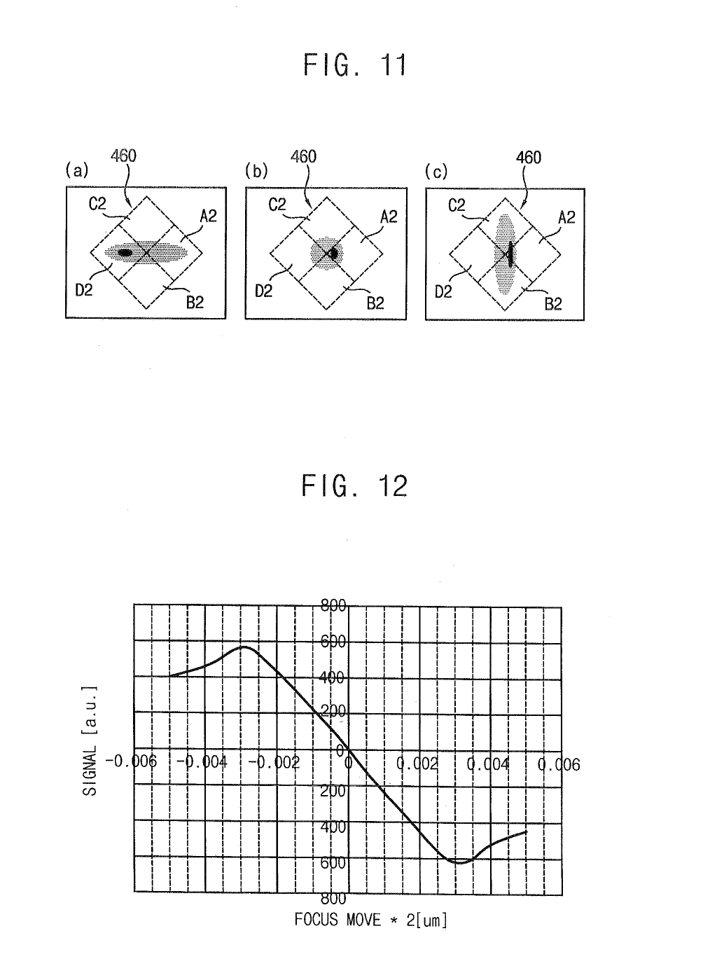

FIGS. 11a to 11c represent light receiving images received in the second light detector 460 and correspond to FIGS. 9a to 9c.

(FIGS. 9a to 9c and FIGS. 11a to 11c are related to have a symmetric plane of −45° (that is, 135°))

Four light receiving portions are represented in order by A to D, for example, a light receiving signal from a light receiving portion A is represented by ‘SA’ (when the light receiving portion is one of the light receiving portions of the second light detector, the light receiving portions are represented by A2 to D2, further, for example, the light receiving signal from the light receiving portion ‘A2’ is represented by ‘SA2’).

The mirror image relation to each other means that disturbance due to the defective portion (non-uniform light amount distribution) is generated to a same amount at each mirror image position of the first light detector 440 and the second light detector 460.

Accordingly, the light receiving signal from the first light detector 440 (focus error signal FE1) and the light receiving signal from the second light detector 460 (focus error signal FE2) are added or subtracted properly to cancel the disturbance (non-uniform light amount distribution).

Referring to FIG. 11b and FIG. 9b, disturbance is generated in the light receiving portion B1 in FIG. 9b, and disturbance is generated in the light receiving portion A2 in FIG. 11b.

In here,

FE1=(SA1+SD1)−(SB1+δ+SC1)

FE2=(SA2+δ+SD2)−(SB2+SC2)

The total focus error signal FEt is defined in the following equation.

$$\begin{matrix}FEt = FE 1 + FE 2 \\ = ( SA 1 + SD 1 + SA 2 + SD 2 ) - ( SB 1 + SC 1 + SB 2 + SC 2 )\end{matrix}$$

Thus, an effect of the disturbance is removed from the total focus error signal FEt. The total focus error signal (FEt) is represented by FIG. 12.

In case of the mirror image relation to each other, since a direction of astigmatism is identical, the total focus error signal can be obtained by the above-mentioned equation. However, in case of a non-mirror image relation by further bending using mirrors, a direction of astigmatism is rotated by 90 degrees, to thereby obtain the same effect.

Therefore, a non-uniform light amount distribution can be prevented from occurring due to the irregular pattern on the surface of the semiconductor wafer, and a distance adjustment between the optical unit 200 and the semiconductor wafer surface can be stabilized.

By a description so far explained, it would be understood that the auto focus control system 300 can control a position of the semiconductor wafer surface to be defocused by a predetermined distance.

Accordingly, because a gap between the optical unit 200 and the semiconductor wafer surface are maintained constant, the optical system 620 of the observation optical system 600 can be focused with respect to the semiconductor wafer surface based on the previously expected defocus.

### Modified Example Embodiment 1

A modified example embodiment will be explained.

As illustrated in FIG. 2, although the beam spot 701 used in the auto focus control system 300 is away from the observation region 702 of the observation optical system 600, the beam used in the auto focus control system 300 may leak to the observation optical system 600.

A light may be reflected from the surface of the semiconductor wafer in an irregular direction, and further, a reflection light by the objective lens 320 may enter the observation optical system 600.

In here, as a modified embodiment, the laser diode 311 as a light source may be pulse driven.

The light receiving signal may be sampled and hold in a timing period when the laser diode is ON.

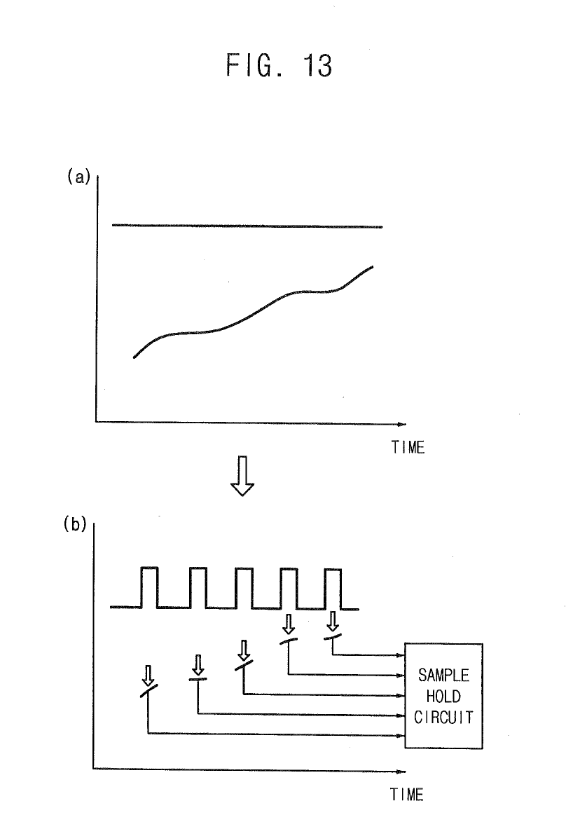

When a duty of the driving pulse is reduced to 1/56 (FIG. 13b), an amount of a flare leaking to the observation optical system 600 is reduced to ⅕, as compared with the continuously driven laser diode 311 (FIG. 13a).

Further, the present invention is not to be construed as limiting of example embodiments, and it would be understood that many modifications are possible in example embodiments without materially departing from the novel teachings and advantages of the present invention. According to the present invention, a stable auto focus adjustment is possible for even irregular surface patterns.

Accordingly, the present invention may be applied to a semiconductor wafer inspecting apparatus as well as a microscope.

When two light beams separated by the unpolarized beam splitter 420 are not in a mirror image relation, directions of producing astigmatism are set to be opposite to each other.

What is claimed is:

1. An auto focus control apparatus for controlling a relative position of a surface of an object with respect to an observation plane in order to inspect the surface of the object using an observation optical system including an image sensor, comprising:
a light source optical system including a light source which emits a focus error detecting light;
a condenser lens condensing the focus error detecting light to an incident light to the surface of the object;
a light receiving optical system receiving a reflection light from the object through the condenser lens; and
a focus error signal generator generating a focus error signal using a receiving signal from the light receiving optical system,
wherein the light receiving optical system comprises
an unpolarized beam splitter separating the reflection light from the object into a first reflection light and a second reflection light;
a first astigmatism producing means arranged on an optical path of the first reflection light;
a second astigmatism producing means arranged on an optical path of the second reflection light;
a first light detector receiving a light passing through the first astigmatism producing means; and
a second light detector receiving a light passing through the second astigmatism producing means,
wherein the focus error signal generator generates the focus error signal using the receiving signal from the first light detector and the second light detector,
wherein the light source optical system is arranged such that an image forming point of the focus error detecting light is defocused from the observation plane by a predetermined distance, and
wherein the light receiving optical system comprises an offset adjustment lens which adjusts such that the reflection light of the light defocused from the observation plane by the predetermined distance is focused on receiving surfaces of the first light detector and the second light detector.

2. The auto focus control apparatus of claim 1, wherein the first light detector and the second light detector are quadrant detectors having four divided light receiving portions, and
a process of generating the focus error signal by the focus error signal generator comprises a process of adding light receiving signals from the corresponding light receiving portions of the first light detector and the second light detector or subtracting one from the other.

3. The auto focus control apparatus of claim wherein the offset adjustment lens is a lens for offset adjustment, which is arranged between the unpolarized beam splitter and the objective lens.

4. The auto focus control apparatus of claim 3, further comprising an actuator moving the offset adjustment lens forward or backward in an optical path.

5. The auto focus control apparatus of claim 1, wherein the light source optical system further comprises a collimator lens collimating the light from the light source into parallel light beams and a condenser lens condensing the light from the collimator lens, and the light source, the collimator lens and the condenser lens are provided as one unit, and
wherein the light source optical system as one unit is moved relative to the objective lens along the optical path such that the image forming point of the focus error detecting light is defocused from the observation plane by a predetermined distance.

6. A semiconductor inspecting apparatus, comprising:
the auto focus control apparatus of claim 1, to and an observation optical system including an image sensor;
a stage supporting a semiconductor wafer as the object to be inspected; and
a driving mechanism moving the optical unit and the stage relatively to each other based on the focus error signal and placing the surface of the semiconductor wafer on the observation plane.

7. A microscopic apparatus, comprising:
the auto focus control apparatus of claim 1, and an observation optical system including an image sensor;
a stage supporting the object to be inspected; and
a driving mechanism moving the optical unit and the stage relatively to each other based on the focus error signal and placing the surface of the object on the observation plane.

8. The auto focus control apparatus of claim 2, wherein the offset adjustment lens is a lens for offset adjustment, which is arranged between the unpolarized beam splitter and the objective lens.

9. The auto focus control apparatus of claim 2, wherein the light source optical system further comprises a collimator lens collimating the light from the light source into parallel light beams and a condenser lens condensing the light from the collimator lens, and the light source, the collimator lens and the condenser lens are provided as one unit, and
wherein the light source optical system as one unit is moved relative to the objective lens along the optical path such that the image forming point of the focus error detecting light is defocused from the observation plane by a predetermined distance.

10. The auto focus control apparatus of claim 3, wherein the light source optical system further comprises a collimator lens collimating the light from the light source into parallel light beams and a condenser lens condensing the light from the collimator lens, and the light source, the collimator lens and the condenser lens are provided as one unit, and
wherein the light source optical system as one unit is moved relative to the objective lens along the optical path such that the image forming point of the focus error detecting light is defocused from the observation plane by a predetermined distance.

11. The auto focus control apparatus of claim 4, wherein the light source optical system further comprises a collimator lens collimating the light from the light source into parallel light beams and a condenser lens condensing the light from the collimator lens, and the light source, the collimator lens and the condenser lens are provided as one unit, and
wherein the light source optical system as one unit is moved relative to the objective lens along the optical path such that the image forming point of the focus error detecting light is defocused from the observation plane by a predetermined distance.
